(19) United States
(12) Patent Application Publication
(10) Pub. No.: US 2018/0152379 A1
(43) Pub. Date: May 31, 2018

(54) Communication Method and Apparatus Providing Mobility of Object

(71) Applicant: Korea Advanced Institute of Science and Technology, Daejeon (KR)

(72) Inventors: Myung Chul Kim, Daejeon (KR); Sang Yup Han, Daejeon (KR)

(73) Assignee: Korea Advanced Institute of Science and Technology, Daejeon (KR)

(21) Appl. No.: 15/817,110

(22) Filed: Nov. 17, 2017

(30) Foreign Application Priority Data
Nov. 29, 2016 (KR) 10-2016-0160859
May 12, 2017 (KR) 10-2017-0059371

(51) Int. Cl. H04L 12/743; H04L 29/08; H04L 12/947

(52) U.S. Cl. CPC H04L 45/7453; H04L 49/25; H04L 69/324

(57) ABSTRACT

A communication method and apparatus to provide mobility of an object is disclosed. The communication method to support mobility of an object moving on networks includes forwarding a packet to be transmitted to the object to a network to which the object moves based on an identifier and a locator of the object.

### CROSS-REFERENCE TO RELATED APPLICATION(S)

This application claims the priority benefit of Korean Patent Application No. 10-2016-0160859 filed on Nov. 29, 2016, and Korean Patent Application No. 10-2017-0059371 filed on May 12, 2017, in the Korean Intellectual Property Office, the disclosures of which are incorporated herein by reference for all purposes.

### BACKGROUND

### 1. Field

One or more example embodiments relate to a communication method and apparatus that provides mobility of an object in a network system using an identifier of the object.

### 2. Description of Related Art

Amid a growing importance of mobility and connectivity of various devices and objects including, for example, smart devices and Internet of things (IoT) devices, a new technological trend including, for example, a smart home, a smart work, a smart grid, a smart factory, and a cloud service, has emerged. Thus, a life and culture paradigm has shifted from technology-oriented towards human-oriented one.

As shown in cases of Google glasses, connected cars, wearable devices, and smart healthcare, objects or things are equipped with a networking function. Without a human recognition, objects with such a networking function may communicate with one another or access the Internet, which has now become a new norm. Thus, users may do work and conduct tasks, or use services, anytime and anywhere, without being dependent on a certain device.

Thus, the mobility has become important. However, an approach to support the mobility is currently divided into a mobile communication network, a data center network, and an application service provider.

Traditionally, research on a terminal-based Internet protocol (IP) mobility technology has focused on a mobile communication network, and research on mobility of a virtual machine has been separately conducted based on a data center network, or a cloud network.

The mobility of a virtual machine may be broadly classified into offline mobility and online, or live, mobility. Between the two, the live mobility may be similar to terminal-based mobility in that the virtual machine moves to an arbitrary location with an IP address maintained while the virtual machine is running.

In addition, due to a recent advancement of virtualization technology, an operating system (OS)-level virtualization method such as Docker and Linux containers (LXC) has been receiving a growing attention, and also lightening a weight of a virtual machine is being accelerated. To lighten a weight of a virtual machine, a checkpoint/restore (CR) method may be applied to store and restore a state of a certain running application or process. Such a method may enable application mobility. The application mobility indicates a movement of an application running in a certain host to another host.

In contrast to a limited use of the technology for the mobility of a virtual machine, such a technology for the application mobility may be flexibly used by users as a new service in a mobile communication network environment and also a wired and wireless integrated network environment.

### SUMMARY

An aspect provides technology for providing mobility of an object by forwarding a packet based on an identifier of the object.

According to an aspect, there is provided a communication method to support mobility of an object moving on networks, the communication method including forwarding a packet to be transmitted to the object to a network to which the object moves based on an identifier and a locator of the object.

The object may include a wired/wireless terminal, a virtual machine, an application, and an application session.

The identifier may be configured based on unique information of the object. The unique information may include a universally unique identifier (UUID), an international mobile equipment identity (IMEI), a mobile phone number, and a name and a version of an application.

The identifier may be generated by performing, on the unique information, at least one of combining, processing, or hashing.

The forwarding may include updating the identifier and the locator of the object. The updating may include storing, in a database system, the identifier and the locator after the object moves, inquiring the identifier and the locator from the database system, and inserting the identifier and the locator into the packet.

The database system may be configured by a set of a plurality of objects.

The inquiring may include inquiring the locator using the identifier, and inquiring an identifier and a locator of another object connected to the object using the identifier.

The inserting may include inserting, into the packet, an identifier and a locator of another object connected to the object.

The identifier or the locator may be inserted into a reserved field of the packet. The reserved field may include an optional field and a scalable header.

The forwarding may further include transmitting the packet to another object connected to the object based on the updated identifier and locator.

The communication method may further include inserting, substituting, or deleting data of the packet.

According to another aspect, there is provided a communication device to support mobility of an object moving on networks, the communication device may include a controller configured to forward a packet to be transmitted to the object to a network to which the object moves based on an identifier and a locator of the object.

The object may include a wired/wireless terminal, a virtual machine, an application, and an application session.

The identifier may be configured based on unique information of the object. The unique information may include an UUID, an IMEI, a mobile phone number, and a name and a version of an application.

The identifier may be generated by performing, on the unique information, at least one of combining, processing, or hashing.

The controller may include an updater configured to update the identifier and the locator of the object.

The updater may include a storage configured to store, in a database system, the identifier and the locator after the object moves, an inquirer configured to inquire the identifier and the locator from the database system, and an inserter configured to insert the identifier and the locator into the packet.

The database system may be configured by a set of a plurality of objects.

The inquirer may inquire the locator using the identifier, and inquire an identifier and a locator of another object connected to the object using the identifier.

The inserter may insert, into the packet, an identifier and a locator of another object connected to the object.

The identifier or the locator may be inserted into a reserved field of the packet. The reserved field may include an optional field and a scalable header.

The controller may further include a transmitter/receiver configured to transmit the packet to another object connected to the object based on the updated identifier and locator.

The controller may further include a packet modifier configured to insert, substitute, or delete data of the packet.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating a communication device according to an example embodiment;

FIG. 2 is a diagram illustrating an updater illustrated in FIG. 1;

FIG. 3 is a diagram illustrating an example of a communication system implemented by the communication device illustrated in FIG. 1;

FIG. 4 is a diagram illustrating an example of a flow of operations performed by the communication device illustrated in FIG. 1;

FIG. 5 is a diagram illustrating an example of a network packet according to an example embodiment; and

FIG. 6 is a diagram illustrating an example of an object mobility platform provided by the communication device illustrated in FIG. 1.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

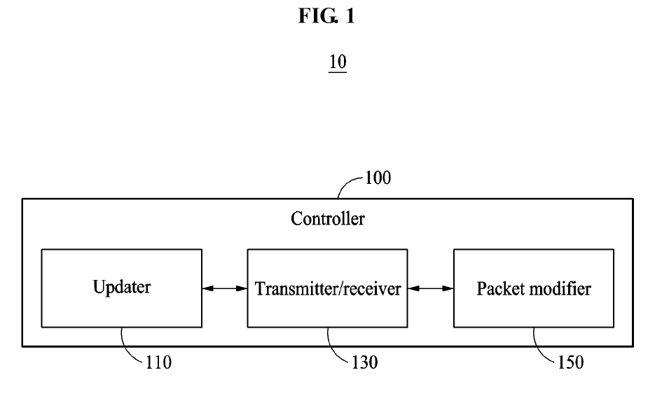

FIG. 1 is a diagram illustrating a communication device 10 according to an example embodiment.

Referring to FIG. 1, the communication device 10 may support mobility of an object. The communication device 10 may provide users with an organic mobility service in a single system, and also maintain a networking service despite a movement of a mobile object on networks. The communication device 10 may support the mobility by continuously updating an object identification table in which an identifier and a locator of an object are distinguished.

According to an existing mobility standard, an Internet Protocol (IP) address of an object may not be maintained when the object moves. Thus, additional tasks including, for example, IP address re-allocation and network connection re-setting, may need to be performed to enable an application service. However, due to such tasks as the address re-allocation and the connection re-setting, a user may experience a disconnection of the network and the application service, and also experience inconvenience because the user needs to wait until the application service resumes.

In addition, in the existing mobility standard, such as, for example, a mobile IP (MIP), a proxy MIP (PMIP), and a locator/identifier separation protocol (LISP), mobility of only a user terminal may be provided, and mobility of a virtual machine, an application, an application session, and the like may not be provided. For example, in such an existing mobility supporting protocol including the MIP, a terminal may need to be modified and may become slow accordingly.

In such an existing standard, a terminal may be recognized mainly using an IP address, and thus an object recognition unit may remain at a terminal level. In addition, in the existing standard, a virtual machine, an application, an application session, and the like that operate in a terminal may not be recognized, and thus mobility may not be provided to such objects.

In the existing standard, in a case in which a single subdivided mobile object such as an application or an application session moves on a network, for example, when an IP address of the mobile object, a port number, and an operating system (OS) and a system to which the object belongs changes, packet forwarding (or routing) may not be desirably performed on the network to prevent the network connection re-setting.

Thus, in the existing standard, when a logic-unit object such as an application or an application session moves, such a movement may not be detected and, if detected, the packet forwarding may not be desirably performed.

In addition, when the number of objects increases exponentially, the existing standard may not have a desirable measurement to handle such an increase, and security for a mobile object may be degraded. That is, in the existing standard, when the number of objects increases, traffic may be concentrated on a certain network equipment, and such a rapid increase in traffic may hinder a normal operation of the network equipment and slow down the network equipment, and thus a user quality may be degraded. Further, in terms of security, the existing standard may be vulnerable to an intermediate attack targeting a certain mobile terminal.

The communication device 10 may perform forwarding or routing based on an identifier of an object, in lieu of a location of the object, and thus may forward or route a packet by determining a changed location of the object based on the identifier of the object despite a movement of the object.

The communication device 10 may provide an improved user experience and a differentiated service, compared to the existing standard such as the MIP, the PMIP, and the LISP. The communication device 10 may support mobility of a terminal, mobility of a virtual machine, mobility of an application, mobility of an application session, and the like. The communication device 10 may support mobility of various objects connected to the Internet. The objects may include, for example, a smartphone, a tablet, a wearable device, a home appliance, a smart meter, a smart factory machine, and the like.

The communication device 10 may also provide scalability by applying a plurality of nodes to a database system to accommodate a plurality of users and mobile objects. The communication device 10 may store, in a distributed or centralized manner, data associated with object information.

Through the centralized storing of the data, convenience in managing the data may be improved and immediate updating of the data may be enabled. However, a vulnerability to a single point of failure (SPOF) may increase, and performance of an entire system may be degraded when the number of mobile objects increases dramatically.

In contrast, through the distributed storing of the data as in a distributed hash table (DHT), the scalability may be improved, and robustness against a failure of some network equipment may also be improved. However, such a distributed storing method may increase complexity of the system, and increase an amount of time to update the data.

Although, in the existing standard, the communication device 10 may be vulnerable to a security issue such as an intermediate attack, the communication device 10 may enhance security through a multiple hash-based method. That is, although an unauthorized attacker captures a plurality of packets halfway, the communication device 10 may disable the unauthorized user to reconstruct the packets to a single session flow and enhance security of a user session by assigning different object identifier or hash values to a same object.

The communication device 10 may maximally maintain compatibility with an existing network. The communication device 10 may provide effective routing, and provide advantages of load balancing through distributed storage of mobility information including, for example, an identifier and/or locator of an object.

The communication device 10 may support mobility on a network, and thus support mobility of an object without a modification to a terminal. That is, the communication device 10 may not need to modify the terminal to provide the mobility by a software (S/W) unit, but provide the mobility by modifying an OS and a S/W library that operate in the terminal.

In addition, the communication device 10 may maintain compatibility with an existing network system, equipment, and terminal. To provide mobility of an object, the communication device 10 may use an existing network equipment, excluding a network access switch or router disposed at an edge of a network.

The communication device 10 may provide effective routing. Existing mobility support methods may have an ineffective triangular routing issue. In contrast, the communication device 10 may not set a fixed routing route to support mobility, and thus may not generate such a triangular routing issue. The communication device 10 may perform routing based on information of a network switch or router in which a terminal is located, and thus perform the routing with transparency for mobility of an object through a network.

The communication device 10 may distribute a load through distributed storage of mobility information. The communication device 10 may store, through distribution, the mobility information in a network equipment or device such as a switch and router, or in a separate terminal and a server. Through such a distributed storage structure, the communication device 10 may thus prevent requests for the mobility information from being concentrated on a certain network device, and increase an efficiency in the distribution by dynamically adjusting the number of nodes participating in the distribution. In addition, the communication device 10 may store a copy of the information through distribution, and thus may continuously provide a mobility service using the copy despite occurrence of a failure of a certain switch or router.

A network in which the communication device 10 is used may include a large network, and a plurality of subnetworks included in the large network. Each of the subnetworks may correspond to a single network access switch.

The network access switch refers to a switch connected directly to an object, and a switch that is not connected directly to the object, for example, a router, a border, and a gateway, may be defined as a network switch.

As illustrated in FIG. 1, the communication device 10 includes a controller 100.

The controller 100 may forward a packet to be transmitted to a network to which a mobile object moves, based on an identifier and a locator of the object. The controller 100 may update the identifier and the locator of the object. The controller 100 may transmit the packet to another object connected to the object based on the updated identifier and the updated locator, and may insert, substitute, or delete data of the packet.

The controller 100 may assign mobility to a network switch through a protocol between the controller 100 and the network switch, or restore a faulty switch. The protocol may include an openflow protocol, a pseudo software-defined network (SDN) protocol, a simple network management protocol (SNMP), and the like.

The object described herein may include a wired/wireless terminal, a virtual machine, an application, and an application session. The wired/wireless terminal may be embodied as, for example, a personal computer (PC), a data server, and a portable device.

The portable device may be embodied as, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, and a smart device. The smart device may be embodied as, for example, a smart watch, a smart band, and a smart ring.

The identifier of the object may be configured based on unique information of the object. The unique information may include a universally unique identifier (UUID), an international mobile equipment identity (IMEI), a mobile phone number, and a name and a version of an application. The identifier may be generated by performing, on the unique information, at least one of combining, processing, or hashing.

The identifier of the object may indicate a symbol used to identify a communication object on a network. For example, the identifier may include a domain name system (DNS) name and an object identification (ID).

The locator of the object may indicate a symbol used to designate a location of a communication object on a network. For example, the locator may include an IP address of the object and a combination of the IP address and a port number.

The controller 100 may be included in a network system that is configured using the communication device 10, or in each of a plurality of devices included in the network system. Alternatively, only a portion of the controller 100 may be included in each of the devices included in the network system.

Alternatively, the controller 100 may be included in a plurality of objects, and each of the objects may include only a portion of the controller 100. In a case of the object being S/W, the controller 100 may be implemented in hardware to which the S/W belongs.

The controller 100 may be designed in a centralization or distribution type, and object information including, for example, the identifier and the locator of the object, may be stored in the controller 100 or in a separate database system.

When designing the controller 100 in the centralization type, the controller 100 may include a central controller and a sub-controller. The sub-controller may be included in the plurality of devices included in the network system, and the central controller may control a plurality of sub-controllers. When designing the controller 100 in the distribution type, the controller 100 may be included in each of the devices included in the network system, and each of controllers may perform same operations as the central controller.

When storing the object information in the controller 100, implementation and designing may be simply performed. However, as a size of the network increases, a load of the controller 100 may increase and a round-trip delay may also increase. Thus, a storage may be separated from the controller 100 and disposed in the separate database system, or a storage of the database system and a storage of the controller 100 may be set to be a main storage and a sub-storage, respectively. Also, a distribution-type database system in which storages of all objects in the network participate may be applied.

For example, the controller 100 may be embodied as a DHT system. Since a hash table is managed by distributed nodes, a DHT may be scalable and used in a distributed file system such as a peer-to-peer (P2P) system and Cassandra developed by Facebook. Such a distributed system may be highly stable, and thus used as a base system for an electronic and virtual currency such as bitcoin.

As illustrated in FIG. 1, the controller 100 includes an updater 110, a transmitter/receiver 130, and a packet modifier 150.

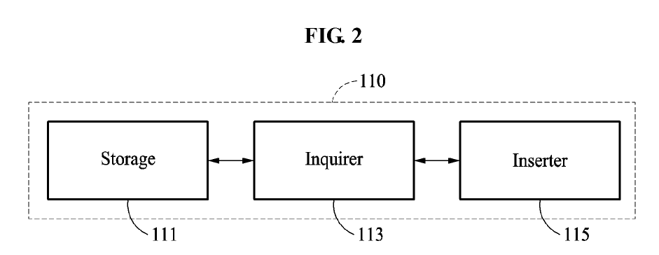

The updater 110 may update the identifier and the locator of the object. Operations of the updater 110 will be described in detail with reference to FIG. 2.

The transmitter/receiver 130 may receive a packet from another object connected to the object, and transmit a packet to another object connected to the object.

The transmitter/receiver 130 may output the received packet to the updater 110 and the packet modifier 150.

The packet modifier 150 may insert, substitute, or delete data of the packet. The packet modifier 150 may transmit a packet modification rule to an object. In response to the packet modification rule being received, the object may insert, substitute, or delete the packet in accordance with the received packet modification rule.

FIG. 2 is a diagram illustrating the updater 110 illustrated in FIG. 1.

Referring to FIG. 2, the updater 110 may update an identifier and a locator of a mobile object. When the object moves, and the identifier and the locator of the object change in response to such a movement, the updater 110 may store such a change in the identifier and the locator in a database system, inquire the stored identifier and the stored locator from the database system, and insert the retrieved identifier and the retrieved locator into the packet. Here, inquiring an identifier and/or locator from a database system may also mean searching the database system for the identifier and/or locator, or referring to the database system for the identifier and/or locator, and retrieving the identifier and/or locator from the database system.

As illustrated in FIG. 2, the updater 110 includes a storage 111, an inquirer 113, and an inserter 115.

After the object moves, the storage 111 may store the identifier and the locator of the object in the database system. In addition, the storage 111 may generate the identifier of the object.

For example, the identifier of the application object may be generated as follows. The storage 111 may generate a character string, for example, {RemoteDesktop_v1.00_8039}, by combining name and version information of an application, and a port number being used. The storage 111 may generate the identifier, for example, {C9EC1DD8B . . . (omitted)} using a secure hash algorithm (SHA)-256 based on the generated character string.

For another example, the storage 111 may slice words every three letters from the combined character string, for example, {“Rem,” “ote,” “Des,” “kto,” “p_v,” “1.0,” “0_8,” “039”}, extract a first letter from each three letters, and generate the identifier, for example, {RoDkp100}.

The database system may be configured by a single object, or a set of a plurality of objects. That is, the database system may be implemented in a network switch, the controller 100, and an object. The database system may include the storage 111.

For example, the database system may include a server/client model and a DHT system. In addition, the database system may store, in a local cache, retrieved identifier information to inquire an identifier more rapidly.

For example, in a case of the server/client model, a central controller may function as a server, and the storage 111 of each network switch may function as a client.

For example, in a case of the DHT system, the storage 111 of each network switch may be nodes at a same level that are included in the DHT system and store data through distribution.

In a network switch, the storage 111 may include two layers. An upper layer of the two layers may function as a server/client or a DHT node, and a lower layer of the two layers may function as a local cache. The local cache of the lower layer may receive data from the upper layer, and cache the received data therein. Each switch may include a lower cache, and thus improve a communication speed.

The network switch may include a network access switch.

The data to be stored in the storage 111 may be represented by a hash table. The storage 111 may use the identifier of the object as a key of the hash table, and use an identifier and a locator of at least one object connected to the object as a value of the hash table.

The storage 111 may explicitly store, in a destination address field of an IP header, an IP address of a next network switch or router and location information, for example, an IP address, of the object.

The inquirer 113 may inquire the identifier and the locator of the object from the database system. The inquirer 113 may inquire the locator of the object using the identifier of the object, and inquire an identifier and a locator of another object connected to the object using the identifier of the object.

The inquirer 113 may map various sets of information to the identifier of the object. Data to be mapped by the inquirer 113 may include the locator of the object, and an identifier and a locator of a network switch connected to the object. That is, when the inquirer 113 inquires an identifier of an object, the inquirer 113 may also inquire an identifier and a locator of another object connected to the object of which the identifier is retrieved.

The inquirer 113 of the network switch may inquire the identifier of the object from a local data structure, for example, a cache and a temporary table, stored in the storage 111 of the network switch, and obtain location information of the object.

In response to an absence of the identifier to be retrieved from the local data structure, the inquirer 113 may obtain the location information of the object by referring to the DHT system for the identifier. The storage 111 may store, in the local data structure, data retrieved from the DHT system, and thus reduce an amount of time for inquiring an identifier of a next network switch.

The inquirer 113 may refer to a forwarding or routing table in the network switch for the location information of the object, for example, the locator of the object, and then recognize a next network switch or router at which a packet arrives next.

The inserter 115 may insert, into the packet, the retrieved identifier and the retrieved locator of the object. The inserter 115 may additionally insert, into the packet, an identifier and a locator of another object connected to the object. In addition, the inserter 115 may set a destination to which the packet is to be forwarded and transmitted and transmit, to the transmitter/receiver 130, the packet into which the identifier and the locater are inserted and in which the destination is set.

The identifier and the locator may be inserted into a reserved field in the packet. The reserved field may include an optional field and a scalable header.

For compatibility with another network system or device, the inserter 115 may add, to the packet, the optional field or the scalable header including identifier information of the object, or modify or delete the optional field or the scalable header in the packet.

The inserter 115 may transmit and/or receive cashed information of the object by communicating directly with the local cache of the lower layer of the storage 111.

In addition, the inserter 115 may remove the inserted identifier and the inserted locator of the object from the packet to enhance compatibility with an existing network system. This is because, when the inserter 115 removes a mobile header from a packet, a general IP packet may be generated.

In a case in which the transmitter/receiver 130 receives a packet in which a mobile header is not included, the inserter 115 may generate an identifier of an object in the mobile header, and insert the mobile header into the packet.

In a case in which the transmitter/receiver 130 receives a packet in which a mobile header is included, the inserter 115 may refer to the mobile header of the packet for an identifier of an object, and determine whether to forward the received packet to another switch or transmit the received packet to a connected object by removing the mobile header. For example, in a case of a network switch connected to an object and having identifier information of the object, when the transmitter/receiver 130 receives a packet including a mobile header, the network switch may remove the mobile header from the packet and transmit the packet from which the mobile header is removed to the object. In other cases, when the packet including the mobile header is received, the packet may be forwarded to another switch.

An object and a network device in which the inserter 115 is embodied may include a S/W library, an OS, a terminal, and a network switch.

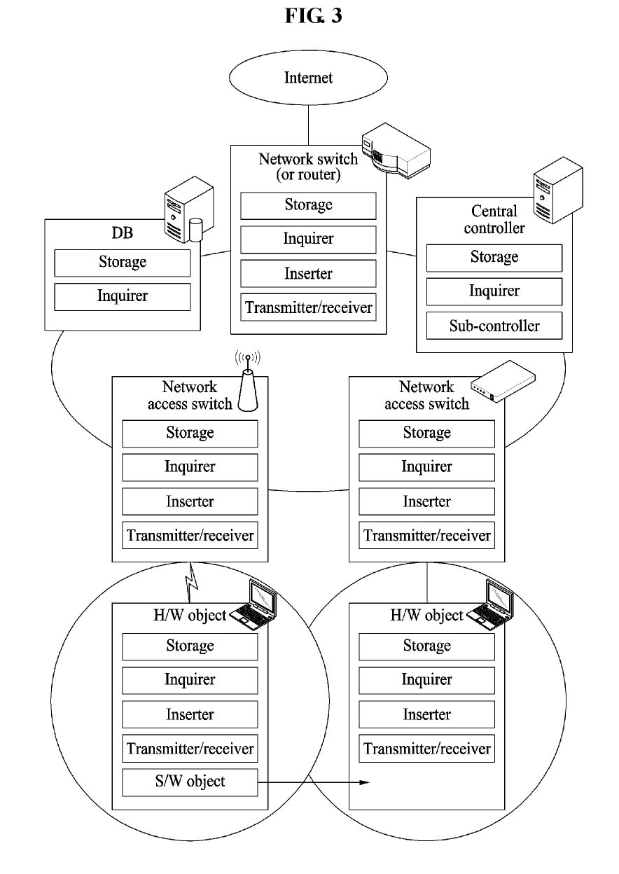

FIG. 3 is a diagram illustrating an example of a communication system implemented by the communication device 10 illustrated in FIG. 1.

Referring to FIG. 3, the communication system includes a plurality of network devices that provide a mobility function. The network devices may include a network switch or router, a network access switch connected to a wired/wireless terminal, and a central controller configured to manage the devices described in the foregoing. The network switch may include a wired switch, an access point (AP), a base station (BS), and the like.

A network device may include a network switch, a network access switch, a separate database (DB as illustrated), and an object. Each of the network devices may be implemented by the communication device 10, or implemented by including some components of the communication device 10. The network devices may include different components. That is, each of the network devices may perform, substantially the same as described, a portion and/or entirety of operations of the communication device 10 described above with reference to FIGS. 1 and 2.

For example, the network switch, the network access switch, and the terminal may include the storage 111, the inquirer 113, the inserter 115, and the transmitter/receiver 130. The database may include the storage 111 and the inquirer 113.

Although the storage 111, the inquirer 113, the inserter 115, and the transmitter/receiver 130 are illustrated as being separately configured, they may be included in a separate controller as described above with reference to FIGS. 1 and 2. Here, the separate controller may control the network switch, the network access switch, the database, and objects. Here, the central controller may operate as a main controller, and the separate controller of each of the network devices may operate as a sub-controller.

For example, as illustrated in FIG. 3, a network system designed as being a centralization type may be configured by the central controller and a plurality of sub-controllers. Here, the central controller may control the sub-controllers.

The central controller may transmit a packet including a routing rule to a network switch. Through the routing rule, a packet processing method for the packet may be defined. In addition, the central controller may define a packet processing role and method by selecting a network switch to or from which a mobile header is to be added or deleted.

The central controller may transmit, to a network switch, an activation/inactivation command packet to activate or inactivate a port of the network switch. In addition, the central controller may transmit, to individual network switches, a command packet associated with a state report and a routing rule report to obtain state information and routing rules of the network switches.

The network switches may share mobility information of the objects through a communication protocol among the network switches, for example, an SDN protocol and a routing protocol for an exchange of links (or routers) and state information. A network switch may perform routing based on an optimal route to a network access switch or an AP at which an object is present.

For example, a network switch may notify information, for example, an identifier, of a newly connected object, to the central controller and a nearby switch by transmitting a ‘new connection notification’ packet to the central controller and the nearby switch. The central controller may determine whether the object enters a network completely newly, or the object moves after being connected to another network switch. When the object moves after being connected to another network switch, the central controller may notify movement information associated with such a movement to another network switch having information of the object. A network switch receiving such a notification of the movement information may transmit, to a network switch connected to the object, a data packet heading for the object.

In a case of a mobile object is a H/W object such as a laptop computer and a smartphone, a network access switch may support mobility of the object. In a case of a mobile object is a S/W object such as a virtual machine, an application, and an application session, a mobility function may be provided to a H/W object to support mobility of such an object. In such a case, a target to which the mobility function is to be provided may be a H/W object to which a S/W object belongs. For example, the H/W object may be a wired/wireless terminal, or a network switch.

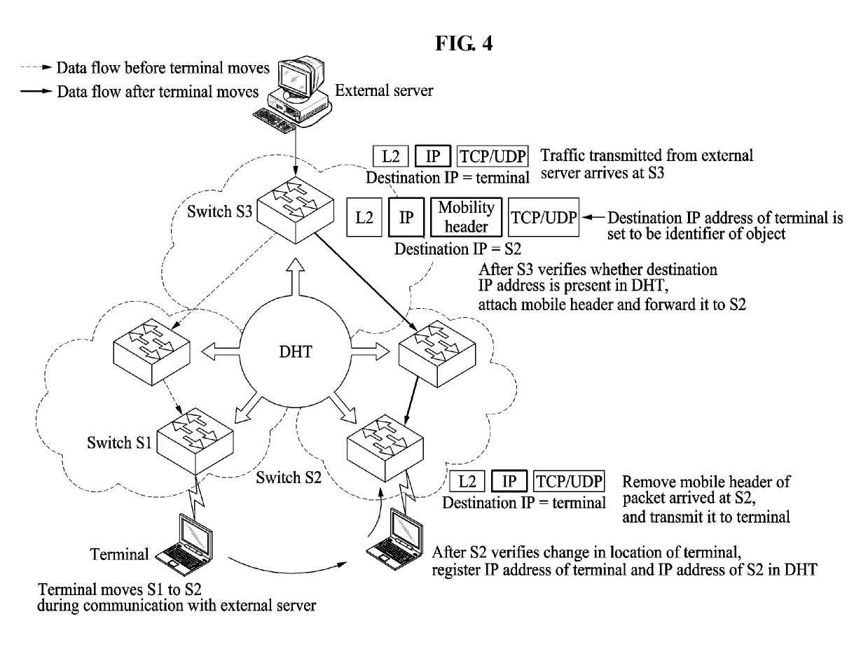

FIG. 4 is a diagram illustrating an example of a flow of operations performed by the communication device 10 illustrated in FIG. 1

Referring to FIG. 4, when an object, for example, a terminal, which is communicating with an external server, moves from network switch S1 to network switch S2 during the communication, the network switch S2 may detect a connection of the object that moves. Here, a network switch may determine whether an object is connected or not based on a frame that is transmitted, through a wire or wirelessly, from the object on a periodic basis, for example, using a general broadcasting method, or on a connection request frame that is transmitted from the object for a new connection in a link layer.

In a case of an object being a virtual machine, an application, and an application session, in addition to an object being a terminal, the communication device 10 may insert an identifier of an object into a packet to be transmitted and/or received to determine whether the object moves.

A network switch may transmit, to the controller 100 or a database system, information indicating that the moved object is connected to the network switch, along with an IP address of the terminal and an IP address of the network switch. Another network switch on a network may inquire which switch the object is connected to using the inquirer 113.

As illustrated, when network switch S3 receives a packet of which a destination IP address indicates the object, the controller 100 may notice, through a DHT and a forwarding table, that the received packet needs to be forwarded to the network switch S2.

In a case in which the initially received packet does not include a mobile header, the inserter 115 of the network switch may set the identifier of the object to be the destination IP address. In such a case, both an identifier and locator to be inserted into the mobile header may be IP addresses.

The inserter 115 of the network switch S3 may set the destination IP address to be the network switch S2, and store the identifier of the object in a form of an ID value. The inserter 115 may insert, into the packet, an optional field or a scalable header in which the identifier of the object is stored. When the packet arrives at the network switch S2, the inserter 115 of network access switch S2 may set the destination IP address to be the object's one based on inserted identifier information associated with the identifier of the object. Subsequently, the transmitter/receiver 130 of the network switch S2 may transmit the packet to the object.

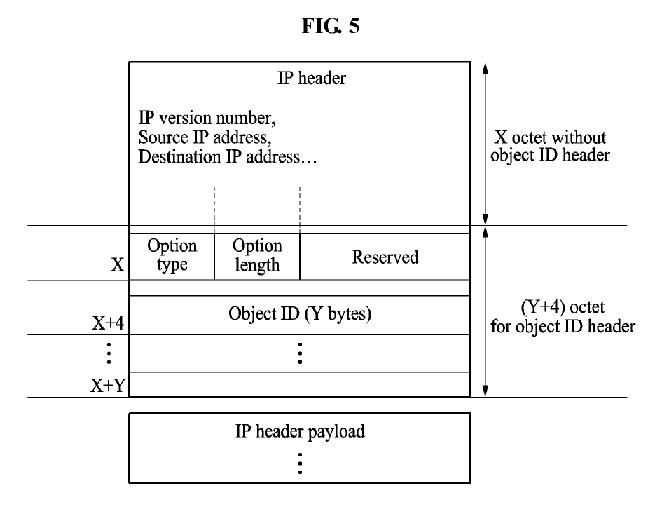

FIG. 5 is a diagram illustrating an example of a network packet according to an example embodiment.

Referring to FIG. 5, an identifier of an object may be stored in an object ID header of a network packet by the inserter 115. The header may be added in a form of an optional field of an existing IP version 4 (IPv4) header, or in a form of a scalable header of an IP version 6 (IPv6) header. The inserter 115 may insert the identifier and a locator of the object into a reserved field or an unused field of such an existing packet header, and thus enhance compatibility with an existing network system.

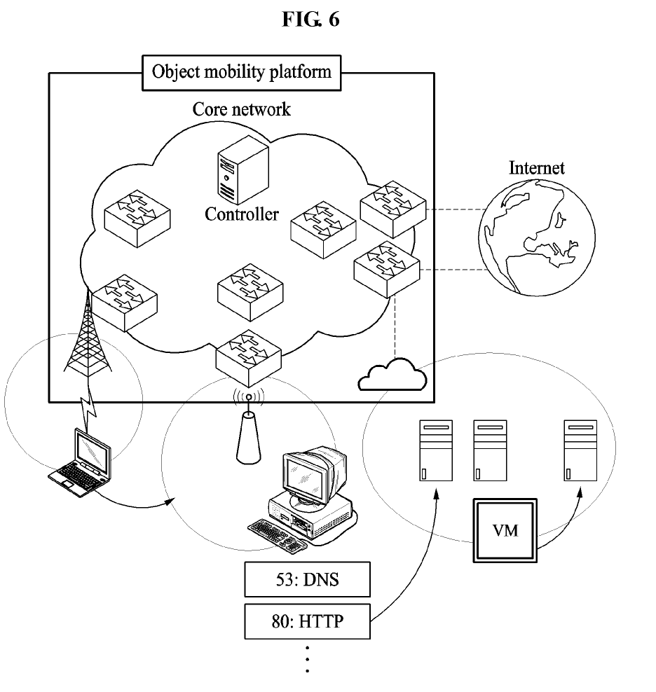

FIG. 6 is a diagram illustrating an example of an object mobility platform provided by the communication device 10 illustrated in FIG. 1.

Referring to FIG. 6, the communication device 10 may provide a mobility function to various objects based on an object mobility platform. As described above, the communication device 10 may provide mobility to all possible objects including a wired/wireless terminal, a virtual machine, an application, an application session, and the like. The communication device 10 may provide mobility to a detailed object such as an application and an application session. Thus, the communication device 10 may enable various application scenarios that are impossible in an existing computing environment. Through the mobility of an application unit or an application session unit, the communication device 10 may provide a user with a new user experience as follows.

The communication device 10 may perform a dynamic kernel change. An existing network system may require re-booting to update a kernel, and all user applications that are running may need to be terminated for the re-booting. In contrast, the communication device 10 may change the kernel by moving a user application to another host without an interruption or suspension of the user application.

The communication device 10 may distribute a load of a network. The communication device 10 may support mobility for an application, and thus may move a running application to an arbitrary host, for example, a server, on another network. Thus, the communication device 10 may distribute network traffic that may be concentrated on a certain host and application of a network. In addition, the communication device 10 may maintain a networking service without an interruption or suspension of the networking service of the application that moves.

The communication device 10 may provide high-performance computing. Through mobility of an application, the communication device 10 may enable an operation requiring a high-performance to be implemented in a high-performance device and obtain a corresponding result, despite use of a low-cost and low-specification device. The communication device 10 may transmit, to a user terminal, a resulting application obtained by performing such a high-performance operation without a network interruption or suspension of an application service.

The communication device 10 may perform application debugging. In an existing network system, when an error occurs in an application installed in a user terminal, the debugging may be performed by receiving an application log and analyzing the application log, or the debugging may be performed directly on a corresponding device through a remote connection. In contrast, the communication device 10 may move the application with the error from the user terminal to a developer computer through mobility of the application, and enable the developer computer to analyze the error and immediately determine a cause of the error, and perform the debugging. The communication device 10 may perform the debugging without the network interruption, and thus may accurately diagnose an issue or a situation of a network object in an OS, for example, a socket.

The communication device 10 may also perform fault recovery. In a case in which a fault occurs in a server of a system, which may invite numerous casualties or huge property losses, the communication device 10 may rapidly move a corresponding application to another host to restore the server from the fault, and thus minimize damage that may be incurred by the fault. The communication device 10 may maintain a service without a network interruption, and prevent an interruption of the service that may occur due to the fault.

That is, the communication device 10 may support mobility of an application on a network, and provide a user with a new computing experience. The communication device 10 may enable mobility of S/W and a session in which S/W is running, in addition to mobility of a H/W terminal and device.

Using the communication device 10, a network operator and a network equipment operator may be relieved of a burden to implement numerous mobility standards and technologies, and enhance compatibility among network devices. Using the communication device 10, an operator may support mobility for various objects, and provide a user with a new user experience through mobility of an application and an application session.

Further, the communication device 10 may support distributed storage of object information to provide an uninterrupted mobility service, in proportion to the number of users or objects. Thus, the communication device 10 may distribute traffic that may be concentrated on a certain network device otherwise, and thus have scalability. A network operator may arrange network devices in proportion to the number of objects in a certain area, and thus provide a stable mobility service to users.

The components described in the example embodiments of the present disclosure may be achieved by hardware components including at least one of a digital signal processor (DSP), a processor, a controller, an application specific integrated circuit (ASIC), a programmable logic element such as a field programmable gate array (FPGA), other electronic devices, and combinations thereof. At least some of the functions or the processes described in the example embodiments of the present disclosure may be achieved by software, and the software may be recorded on a recording medium. The components, the functions, and the processes described in the example embodiments of the present disclosure may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method to support mobility of an object moving on networks, the communication method comprising:
forwarding a packet to be transmitted to the object to a network to which the object moves based on an identifier and a locator of the object.

2. The communication method of claim 1, wherein the identifier is configured based on unique information of the object,
wherein the unique information includes a universally unique identifier (UUID), an international mobile equipment identity (IMEI), a mobile phone number, and a name and a version of an application.

3. The communication method of claim 2, wherein the identifier is generated by performing, on the unique information, at least one of combining, processing, or hashing.

4. The communication method of claim 1, wherein the forwarding comprises:
updating the identifier and the locator of the object.

5. The communication method of claim 4, wherein the updating comprises:
storing, in a database system, the identifier and the locator after the object moves;
inquiring the identifier and the locator from the database system; and
inserting the identifier and the locator into the packet.

6. The communication method of claim 5, wherein the database system is configured by a set of a plurality of objects.

7. The communication method of claim 5, wherein the inquiring comprises:
inquiring the locator using the identifier; and
inquiring an identifier and a locator of another object connected to the object using the identifier.

8. The communication method of claim 5, wherein the inserting comprises:
inserting, into the packet, an identifier and a locator of another object connected to the object.

9. The communication method of claim 4, wherein the forwarding further comprises:
transmitting the packet to another object connected to the object based on the updated identifier and locator.

10. The communication method of claim 1, further comprising:
inserting, substituting, or deleting data of the packet.

11. A communication device to support mobility of an object moving on networks, the communication device comprising:
a controller configured to forward a packet to be transmitted to the object to a network to which the object moves based on an identifier and a locator of the object.

12. The communication device of claim 11, wherein the identifier is configured based on unique information of the object,
wherein the unique information includes a universally unique identifier (UUID), an international mobile equipment identity (IMEI), a mobile phone number, and a name and a version of an application.

13. The communication device of claim 12, wherein the identifier is generated by performing, on the unique information, at least one of combining, processing, or hashing.

14. The communication device of claim 11, wherein the controller comprises:
an updater configured to update the identifier and the locator of the object.

15. The communication device of claim 14, wherein the updater comprises:
a storage configured to store, in a database system, the identifier and the locator after the object moves;
an inquirer configured to inquire the identifier and the locator from the database system; and
an inserter configured to insert the identifier and the locator into the packet.

16. The communication device of claim 15, wherein the database system is configured by a set of a plurality of objects.

17. The communication device of claim 15, wherein the inquirer is configured to inquire the locator using the identifier, and inquire an identifier and a locator of another object connected to the object using the identifier.

18. The communication device of claim 15, wherein the inserter is configured to insert, into the packet, an identifier and a locator of another object connected to the object.

19. The communication device of claim 14, wherein the controller further comprises:
a transmitter/receiver configured to transmit the packet to another object connected to the object based on the updated identifier and locator.

20. The communication device of claim 11, wherein the controller further comprises:
a packet modifier configured to insert, substitute, or delete data of the packet.
